(19) United States
(12) Patent Application Publication
(10) Pub. No.: US 2016/0086171 A1
(43) Pub. Date: Mar. 24, 2016

(54) Indication of Recurring Transaction for Payment Devices and Credit Cards

(71) Applicants: Eric Gregory Rehe, Alexandria, VA (US); Joseph Ryan Goss, Massapequa, NY (US); John Thomas Wolfe, Weston, MA (US)

(72) Inventors: Eric Gregory Rehe, Alexandria, VA (US); Joseph Ryan Goss, Massapequa, NY (US); John Thomas Wolfe, Weston, MA (US)

(21) Appl. No.: 14/680,525

(22) Filed: Apr. 7, 2015

Related U.S. Application Data
(60) Provisional application No. 61/976,131, filed on Apr. 7, 2014.
(60) Provisional application No. 62/085,760, filed on Dec. 1, 2014.

(51) Int. Cl. G06Q 20/38; G06Q 20/40; G06Q 20/34; G06K 19/06

(52) U.S. Cl. CPC G06Q 20/385; G06K 19/06206; G06Q 20/405; G06Q 20/34

(57) ABSTRACT

A credit card has either a display screen capable of showing either a fully generated transactional credit card number or a partially generated number. In use, a user generates a dynamic “transactional” credit card number associated with his underlying account credit card number. To complete a secure transaction that cannot be copied and used at a later date, the credit card does not display the base credit card number, but instead uses on-card encryption to generate and/or display a transactional cc number that may be may include a portion of the base number or only digits that are generated into the transactional credit card number. The transactional cc number and not the base credit card number are provided to a vendor to complete a transaction. The credit card processing server uses decryption or a reverse lookup table to convert the transactional cc number back to the base cc number.

### CROSS REFERENCE TO RELATED APPLICATIONS

This application claims the benefit of U.S. Provisional Application 61/976,131, filed Apr. 7, 2014, entitled “Indication of Recurring Transaction for Payment Devices and Credit Cards,” which is incorporated herein by reference. This application also claims the benefit of U.S. Provisional Application 62/085,760, filed Dec. 1, 2014, entitled “SECURE CREDIT CARD WITH DYNAMIC NUMBER,” which is incorporated herein by reference.

### BACKGROUND OF THE INVENTION

### 1. Field of the Invention

The present application relates to providing a more secure credit card capable of displaying a time-varying credit card number for use only for transactions during a defined time period and a method of using said card in a transaction.

The overwhelming majority of credit card fraud is from “stolen number fraud.” Thieves steal card number information during transactions, or from hacking into databases that contain the details of completed past transactions, including the credit card numbers. In computer language, this is a “replay” attack, because it is stealing valid credentials and “replaying” them to authorize a fraudulent transaction.

### SUMMARY OF THE INVENTION

By using a dynamic credit card number that changes with time, fraudulent transactions attempted using stolen card numbers can be detected and stopped. A card number that changes every minute (or other time period) will allow an authentic user (anyone with the credit card) to make a transaction and have this transaction be authorized successfully. However, someone who steals that transactional number will not be able to make a transaction with it later, because that number will have expired and can no longer be used in a valid transaction.

This use of a time-variant credit card number is accomplished by giving the card and authentication server a “shared secret” which is used to generate a “one-time” number which can be used to authenticate transactions. This shared secret is preferably used in conjunction with a clock, but for example could be incrementally changed from transaction to transaction, etc. From this shared secret and the current time, the card calculates the current sixteen digit (or other appropriate length card number, e.g., Amex is 15 digits) credit card number. Preferably the user's actual fixed credit card number is not present on the card to prevent a person from gleaning the underlying number from the card. The backend server is also constantly calculating what the correct sixteen digit card number should be for each time. When a user makes a transaction, the sixteen digit card number (“transactional card number”) sent over the network for authorization is matched to a transactional number the backend server has independently computed for that particular card. If the numbers match, the transaction is authorized. If the numbers do not match, then the transaction will be rejected. The transactional credit card number can thus be matched to one particular user account to complete the transaction. Alternate user information such as zip code, street address, user name, etc., can be used to further verify a proper match with the desired user.

Accordingly, it is a principal object of a preferred embodiment of the invention to provide a credit card having a time-variant transactional credit card number to prevent fraud.

It is another object of the invention to provide a time-synched credit card and backend server (“credit card processing server”) that share a common encryption (“number generator”) and seed for converting a transactional credit card number into a user's base credit card number to identify the underlying account and for verifying/approving a credit card transaction.

It is a further object of the invention to provide a backend server system for processing credit card numbers by confirming the user account number from the received transactional number and authorizing the transaction or rejecting the transaction.

Still another object of the invention is to provide a backend server system that can distinguish a valid transactional number from the time period in which it was converted from the base user credit card number to the transactional credit card number.

It is an object of the invention to provide improved elements and arrangements thereof in an apparatus for the purposes described which is inexpensive, dependable and fully effective in accomplishing its intended purposes.

These and other objects of the present invention will be readily apparent upon review of the following detailed description of the invention and the accompanying drawings. These objects of the present invention are not exhaustive and are not to be construed as limiting the scope of the claimed invention. Further, it must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

### BRIEF DESCRIPTION OF THE DRAWINGS

FIG. 1 is a diagrammatic view of a credit card according to at least one embodiment of the invention.

FIG. 2 is a flow diagram showing processing of a credit card transaction according to at least one embodiment of the invention.

Similar reference characters denote corresponding features consistently throughout the attached drawings.

### DETAILED DESCRIPTION OF THE PREFERRED EMBODIMENT(S)

The present invention is to a dynamic credit card number that changes with time.

By using a dynamic credit card number that changes with time, fraudulent transactions attempted using stolen card numbers can be detected and significantly reduced or stopped. A card number that changes every minute (or other time period) will allow an authentic user (i.e., a legitimate “cardholder”) to make a transaction and have the transaction be authorized successfully. However, someone who steals that transactional number produced by the variable credit card will not be able to make a transaction with it later, because that number will have expired and can no longer be used in a valid transaction.

This use of a time-variant credit card number is accomplished by providing the card and authentication server a “shared secret” which is used to generate a “one-time” transactional credit card number which can be used to authenticate a transaction. This shared secret is preferably used in conjunction with a clock, but for example could be incrementally changed from transaction to transaction, etc. From this shared secret and the current time, the card calculates a current sixteen digit (or other appropriate length card number, e.g., Amex is 15 digits) credit card number. At the same time, the backend server also uses the “secret” corresponding to each to each credit card to determine the cardholder associated with any received transactional number. For example, the backend server could generate a list of all known acceptable transactional numbers for a time period for the list of known credit card numbers to generate a lookup list to convert the received transactional number to the cardholder account. Or an algorithm could be used to convert the received transactional number back to the starting cardholder credit card number. However, only transactional numbers valid for the relevant time period will match a credit card number (or a number and the verifying information such as zip code, user name, CCV number, etc.).

Preferably the user's actual fixed credit card number is not present on the card to prevent a person from gleaning the underlying number from the card. The backend server is constantly calculating what the correct sixteen digit card number should be for each time. When a user makes a transaction, the sixteen digit card number (“transactional card number”) sent over the network for authorization is matched to a transactional number the backend server has independently computed for that particular card. If the numbers match, the transaction is authorized. If the numbers do not match, then the transaction will be rejected.

The above description is a general case. There are some specific situations in which the process may vary, for example, there may be a built in tolerance where the backend server will accept numbers that are a little bit ahead of or a little bit behind the “correct” number” to account for transaction time delays or processing delays and/or for clock drift on the card. These instances will be discussed later in more detail below.

Both the credit card itself and the authentication server at the issuing bank are loaded with a pseudo randomly generated “seed” key. The “seed” is a factory encoded (or otherwise stored) random key. Each credit card has a unique key. For each credit card manufactured with a unique key, this unique key is also loaded onto the backend authentication server at the issuing bank. There is a one to one correspondence between a credit card with its embedded key, and its key loaded onto the backend authentication server.

### The Card

The card number changes every minute or other predetermined time period. Note that this time interval is arbitrary. For the time being, we are saying every minute. However, a longer length of time (e.g., every 5 minutes, or every hour, even every day) may prove to be more user-friendly, reliable, and extend battery life. Because of the way card fraud is committed, the average time from when a card number is stolen to when it is used is over 50 days, so each of these time periods will allow for the transactional number to expire before the thief tries to replay the card.

### Card Generates Sixteen Digit Dynamic Card Number

The credit card transactional number is a function of the secret key and the current time. The card communicates this sixteen digit dynamic card number to the card reader, along with the other information traditionally contained on track 1 and/or track 2 of the card. The sixteen digit dynamic card number is the sent over the card network to issuing bank to be authorized. The issuing bank authorizes if the dynamic number matches what it should be for the current time.

### Backend Server

The backend server is loaded with a secret key for each issued card associated with the account numbers for each user. The server also has a clock, which tells it the current time. The server clock and card number are correlated by known methods, and maybe corrected or updated to keep the two clock in synchronization. Given the secret keys and the clock, the backend server is capable of independently calculating the dynamic, transactional credit card shown on any issued card at any given time (using essentially the same function and process that the card uses). This enables the backend server to determine what each original user credit card (“cc”) number “should” be in the particular timer period to preferably build a reverse lookup table to determine the underlying account from the transactional cc number. When one of the issued cards makes a transaction and submits an authorization request, the dynamic credit card number submitted with the authorization request is passed to the backend server for verification. The backend server compares the number submitted from the card to the numbers calculated independently on the backend server. If the numbers match, the user account associated with the dynamic, transactional credit card number is determine and the transaction is authorized as appropriate for the amount of purchase and the credit available to the use. If the numbers don't match any potential transactional numbers, then the transaction is declined. It may also be necessary to match information sent along with the transactional number (such as CCV, zip code, user name, street address, etc.) to the use account to further verify that the information matches that stored in the corresponding user's account before authorizing the transaction.

The server can be set to a certain tolerance to account for events that would cause the two numbers to become out of sync, and therefore not match. For example, this could be that the server will allow numbers to be processed within a 5 minute window after the current timer period has closed. It is important to know that the server will be able to calculate numbers for both current AND future times, and can keep a log of previously valid numbers. This way, the server could allow numbers that are 5 minutes old or numbers that are 5 minutes ahead of the current time.

The main cause for the server and the card to get out of sync would be a phenomenon known as clock drift. Since the card is independent from the server, and may not connect to any data source that has the exact time (ie the US atomic clock), the clock may “drift” over time and show a time that is a few minutes ahead of or behind the “true” time.

TABLE 1

| | Card Number | Backend | |
|---|---|---|---|
| | Transmitted | Number | |
| | (“Transactional | (“User CC | |
| Time | CC number”) | Number”) | Authorize? |
| 3:40 PM | 4060 4502 3762 3957 | 4060 4502 3762 3957 | YES |
| 3:41 PM | 4060 0257 2934 3238 | 4060 0257 2934 3238 | YES |
| 3:42 PM | 4060 0964 3487 2356 | 4060 0964 3487 2356 | YES |
| 3:43 PM | 4060 4280 8653 0873 | 4060 4280 8653 0873 | YES |
| 3:44 PM | 4060 4280 8653 0873 | 4060 1263 4598 3675 | MAYBE |
| | | | (Clock Drift |
| | | | Tolerance - |
| | | | Depends on |
| | | | Settings) |
| 3:47 PM | 4060 4280 8653 0873 | 4060 4628 1309 3687 | NO |
| 3:48 PM | 4060 0257 2934 3238 | 4060 2398 1286 4094 | NO |

### I. In Store Process

An in-store processing of a credit card may occur as follows:
1. A user desires to purchase a particular good or service.
2. The user initiates a card-carried encryption (“number generator”) to generate a dynamic number (“transactional credit card number”) by pressing a button, or the card may generate numbers automatically. The method preferably builds the transaction cc number from the current time, the underlying user cc number and a card-stored seed number. The transactional cc number is then stored to the magnetic strip of the credit card or to other memory device for transfer to a card reader.
3. The user swipes the dynamic credit card the same way they would swipe a standard, existing credit card. The transactional cc number may also be displayed on the front of the credit card
4. The dynamic magnetic stripe emulates the card data, including data from Track 1 and Track 2 so that the card reader perceives the data the same way it would perceive static data from a regular credit card. In this case, the dynamic magnetic stripe is communicating a time-based, pseudo-randomly generated card number at the credit card terminal. Additionally, the transaction information may be sent by other methods including RFID and other remote wireless or wired transactional methods.
5. The existing credit card terminal itself preferably does not perform the authorization of the card number. Instead, it sends the card data over the card network to the issuing bank for authorization.
6. The authentication server at the issuing bank receives the request, and compares the transactional card number received against the independently generated card number of the back end server for that account. Account disambiguation is a combination of the dynamic account number (which is on file at backend server) along with other data transmitted during transaction including cardholder name, expiration date, and CVV value)
7. If the numbers match, and the transaction is otherwise allowed (e.g., the user has sufficient credit to transact the purchase), then the transaction is authorized.
8. If the numbers do not match, the transaction is declined (subject to above-mentioned exceptions for clock drift).

### Protection Against Vulnerability Points at a Store

### Card Number Captured During Transaction at POS Terminal, Via Skimmer

By the time the card number is retrieved from the skimmer and loaded onto a new card, and a fraudulent transaction is attempted, the stolen number will be expired. An expired card number will be declined if a transaction is attempted. Additionally, a transactional card number may expire after a single use to further limit this type of fraud.

### Card Number Captured During Transmission of Card Number to Issuing Bank for Authorization

By the time the card number is retrieved from the skimmer and loaded onto a new card, and a fraudulent transaction is attempted, the stolen number will be expired. An expired card number will be declined if a transaction is attempted.

Card Number Captured in Data Breach—Retailers Usually Keep the Credit Card Numbers that were Used in their Stores on File in a Database Somewhere.

An old number that is retrieved from a breached database will have expired long ago. The numbers stolen from the database will be useless to fraudsters. An expired card number will be declined if a transaction is attempted.

### II. Online Process

The invention can be used to protect against on-line fraud as well.
1. User reads the dynamic credit card number off of the screen, the same way they would read a normal static credit card number. As they read, they type this number in. They also type in the other static information usually required in an online transaction, such as their name, address, CVV number, and card expiration date.
   a. Card may include activation mechanism such as a button or capacitive touch technology that can detect when a person is holding the credit card. That way, the number is only displayed when the user is using the card.
2. It is important to note that the dynamic card number requires no changes to the online payment gateway in order to work.
3. The online payment gateway itself does not perform the authorization of the card number. Instead, it sends the card data over the card network to the issuing bank for authorization.
4. The authentication server at the issuing bank receives the request, and compares the card number received against the independently generated card numbers (“reverse lookup table”) of the backend server for each account. Account disambiguation is a combination of the dynamic account number (which is on file at backend server) along with other data transmitted during transaction including cardholder name, expiration date, and CVV value)
5. If the numbers match and the transaction is otherwise approved, the transaction is authorized.
6. If the numbers do not match, the transaction is declined (subject to above-mentioned exceptions for clock drift)

### Protection Against Vulnerability Points Online

Card Number Captured During Entry (ie Looking Over Shoulder, or Via Hacking into Someone's Computer or Network)

A fraudster would need to use the number within a finite time period such as 1-2 minutes of capturing it. While this is theoretically possible, it is extremely difficult, as the fraudster will need to be entering payment information into a payment gateway as fast as he can read it to make a purchase he has already picked out.

More importantly, committing credit card fraud within a time window of a couple of minutes is not a scalable model. Modern credit card fraud separates the harvesting of credit card numbers from their use. One party steals the numbers, sells them on the deep web, and another party purchases them, and uses them to make purchases. The average time from number theft to number use is around 50 days. Therefore, this system makes it practically impossible to commit large-scale fraud using stolen numbers. An expired card number will be declined if a transaction is attempted.

### Protecting Card Number Captured During Transmission

See above for more detail. In general, by the time the number is used to make a transaction, the stolen number will be expired. An expired card number will be declined if a transaction is attempted.

Protecting Card Number Exposed in a Data Breach—again, retailers usually keep the credit card numbers that were used in their stores on file in a database somewhere

An old number that is retrieved from a breached database will have expired long ago. The numbers stolen from the database will be useless to fraudsters. An expired card number will be declined if a transaction is attempted.

### III. Recurring Transaction/Monthly Bill Process

The process of recurring transactions and monthly bills is a tricky one with dynamic card numbers. We believe our solution to this problem allows dynamic card numbers to be used just as easily as static card numbers.

This process is assuming that the recurring transaction is initiated via a “Card Not Present” transaction, meaning, that the card information is entered manually by reading it off of the card, rather than by swiping the card into a terminal. The vast majority of recurring transactions are done this way. It is possible to do the same system for recurring transactions when one swipes. There is a CVV value embedded in the magnetic stripe that is different from the CVV printed on the back of the card, and this CVV value is transmitted during all card present swipe transactions. With a push of a button, the user could change the standard CVV on the magnetic stripe to a recurring CVV, and this recurring CVV on the magnetic stripe would function identically to the one entered manually that is discussed below. Because we are using a magnetic stripe emulator, changing the data communicated to a magnetic stripe reader is trivial.
1. User reads the dynamic credit card number off of the screen, the same way they would read a normal static credit card number. As they read, they enter this number in. They also enter in the other static information usually required in an online transaction, such as their name, address, and card expiration date.
   a. Card may include activation mechanism such as a button or capacitive touch technology that can detect when a person is holding the credit card. That way, the number is only displayed when the user is using the card.
2. It is important to note that the dynamic card number and Recurring CVV (discussed below) preferably require no changes to the online payment gateway in order to work.
3. IF THE USER WANTS TO AUTHORIZE A RECURRING TRANSACTION, they type in a different CVV value than normal.
   a. To facilitate this, the back of the card is equipped with two CVV values. One CVV value is the “normal” CVV value. The other CVV value (which we call CVV4) has the label “recurring” next to it.
   b. To authorize a standard transaction, the user inputs the normal CVV value
4. TO AUTHORIZE A RECURRING TRANSACTION the user inputs the “Recurring” CVV Value.
   a. When the transaction is submitted to the issuing bank, the issuing bank will accept the transaction with either of the two CVV values.
      i. If the standard CVV is used, the bank will authorize the transaction as usual, as discussed above in the online transaction section. The number will expire as normal
      ii. If the Recurring CVV is used, the bank knows to “hold” this specific dynamic number on file, to allow it to be charged in the future by the same merchant.
5. The online payment gateway itself does not perform the authorization of the card number. Instead, it sends the card data over the card network to the issuing bank for authorization.
6. The authentication server at the issuing bank receives the request, and compares the card number received against the independently generated card number of the back end server for that account. Account disambiguation is a combination of the dynamic account number (which is on file at backend server) along with other data transmitted during transaction including cardholder name, expiration date, and CVV value)
7. If the numbers match, the transaction is authorized.
8. If the numbers do not match, the transaction is declined (subject to above-mentioned exceptions for clock drift)
9. If the Recurring CVV is used (mentioned above in steps 3 and 4), the card number used in conjunction with that transaction is kept open and on file, for that merchant only. For example, if you set up a recurring number with Amazon, and that number is 4060 2736 2847 2084, that number will be able to be used again in future transactions, but ONLY ON AMAZON. If someone tries to use this card number in a transaction from any other merchant, it will be declined.
10. For a monthly (or other amount of time) recurring transaction, the merchant just charges the card number they have on file in conjunction with the recurring CVV value with which they were provided. The issuing bank knows which merchant is submitting an authorization request. The bank compares the merchant submitting the authorization request on the “open” number to the merchant who made the first transaction with that number when it was initialized as a recurring number. If the recurring numbers match AND merchants match, the transaction is authorized.
   a. If an authorized merchant charges a number that is not on file for that merchant, and that number is also not the current dynamic number, the transaction will be declined
   b. If an unauthorized merchant charges a number on file for a different merchant, that transaction will be declined.
11. For transactions where you are keeping a number on file, (ex. Amazon or iTunes)—the user should elect for their card number to be saved. In the future, they can use this saved number for quick purchases from that same merchant. Note, the number used for Amazon will be one number, the number used for iTunes will be a different number.
12. To make a transaction, they log on, check out just like normal. The recurring card number will have been saved. They may be asked to verify the CVV or expiration date of their card in order to complete checkout process, as this is standard procedure on many sites using saved credit cards.
13. The recurring numbers that are “left open” are known by the issuing bank. The issuing bank also can post an interactive list of these numbers online for their customers. Customers can then easily see which numbers are on file with which merchants. Customers can also disable a recurring number at their desire, if they wish to no longer have a number on file with a merchant.

Summary of Recurring CVV
1. Card is equipped with two CVV values—a standard CVV value and a recurring CVV value.
2. Both the regular CVV and the CVV4 values are static numbers printed on the card—Just like a standard credit card. (See image example below)
3. The recurring CVV value is just another 3 or 4 digit code, identical in format to the regular CVV, but a different number. (ie: the CVV and CVV4 could not both be 123—they must be different numbers. Such as, CVV=123, CVV4=456)
4. The regular CVV value is used in conjunction with standard, 1 time transactions. When the standard CVV is used, the card number expires after approximately one minute
5. When the recurring CVV is used, the dynamic credit card number used in conjunction with the recurring CVV is held “open” or “on file” by the issuing bank so that this number can be charged again in the future
6. The number on file will only be able to be charged by the merchant who processed the initial transaction on that number.
   a. For example, if your Wall Street Journal subscription was processed with number 4060 2736 2847 2084, it can be continuously charged to that number. However, no other merchant can charge purchases to 4060 2736 2847 2084.
7. For each merchant you set up recurring transactions with, a different dynamic card number will be associated with that merchant.
8. These numbers will be kept on file by the merchant, in the same way that normal static card numbers are kept on file by merchants.

### Protection Against Recurring Transaction Vulnerabilities

The recurring transaction vulnerabilities are nearly the same as the vulnerabilities for online ordering.

Protection Against Card Number Captured During Entry (i.e., Looking Over Shoulder or Via Hacking into Someone's Computer or Network)

The card number would only be able to be used at the merchant for which it was authorized on the first transaction. So, if a fraudster took your Wall Street Journal credit card number, then they would only be able to make fraudulent transactions by buying from the Wall Street Journal. For cases like this, the usefulness of a stolen number is quite limited to a criminal, and the potential losses are also quite minimal. Because merchants bear some financial responsibility for fraudulent transactions, merchants have systems in place that could detect if two users were using the same card number, or if one person was making a ridiculously large amount of purchases. Essentially, the merchant would be able to detect fraudulent purchase activity with a number they already have on file.

A fraudster would need to use the number within a minute or two of capturing it. While this is theoretically possible, it is extremely difficult, as the fraudster will need to be entering payment information into a payment gateway as fast as he can read it to make a purchase he has already picked out.

More importantly, committing credit card fraud within a time window of a couple of minutes is not a scalable model. Modern credit card fraud separates the harvesting of credit card numbers from their use. One party steals the numbers, sells them on the deep web, and another party purchases them, and uses them to make purchases. The average time from number theft to number use is around 50 days. Therefore, this system makes it practically impossible to commit large-scale fraud using stolen numbers. An expired card number will be declined if a transaction is attempted.

### Protection Against Card Number Captured During Transmission

The card number would only be able to be used at the merchant for which it was authorized on the first transaction. Essentially, the merchant would be able to detect fraudulent purchase activity with a number they already have on file. See Above for more detail.

Also, see above for more detail. In general, by the time the number is used to make a transaction, the stolen number will be expired. An expired card number will be declined if a transaction is attempted.

Protection Against Card Number Exposed in a Data Breach—again, retailers usually keep the credit card numbers that were used in their stores on file in a database somewhere

The card number would only be able to be used at the merchant for which it was authorized on the first transaction. Essentially, the merchant would be able to detect fraudulent purchase activity with a number they already have on file. See Above for more detail.

An old number that is retrieved from a breached database will have expired long ago. The numbers stolen from the database will be useless to fraudsters. An expired card number will be declined if a transaction is attempted.

### IV. Paper Authorization Form Process

The system also protects against fraud in the case of paper (“printed”) forms that are filled out by a user.
1. User reads the dynamic credit card number off of the screen, the same way they would read a normal static credit card number. As they read, they write this number down on an authorization form. They also write down the other static information usually required on a paper authorization form, such as their name, address, CVV number, and card expiration date.
   a. Card may include activation mechanism such as a button or capacitive touch technology that can detect when a person is holding the credit card. That way, the number is only displayed when the user is using the card.
2. It is important to note that the dynamic card number requires no changes to the paper authorization form in order to work.
3. The merchant receives the card number from the authorization form, and sends the card data over the card network to the issuing bank for authorization. This may occur via mechanism of internet or phone transfer from the merchant, or another form of authentication.
4. The authentication server at the issuing bank receives the request, and compares the card number received against the independently generated card number of the back end server for that account. Account disambiguation is a combination of the dynamic account number (which is on file at backend server) along with other data transmitted during transaction including cardholder name, expiration date, and CVV value). In the case of a paper form,
5. In the case of a paper form, the number on the paper form will likely have expired a few days prior. Therefore, the issuing bank must be able to recognize which merchants are authorized to make transactions using paper forms, and allow them to use expired numbers. In this case, the paper form authorization number would be compared with the server generated numbers for up to five (5) days prior. If the number on the paper form is recent to within 5 days, the transaction will be authorized. (This number of days is adjustable by the issuing bank to their specific risk tolerance)
6. If the numbers do not match a valid number in the previous 5 days, the transaction is declined. (again, this number of days could be adjustable by the issuing bank to their risk tolerance).

### Paper Authorization Form Additional Information

If the fact that they are using a paper authorization form is known, then issuers can authorize transactions against paper forms more leniently, for example, giving a period of a few days back on numbers. This would still be relatively secure, given the fact that old numbers could only be processed by paper authorization form processors. For this to work, the issuer would have to recognize merchants that a recently expired number is coming from, and have them on an approved white list of vendors allowed to process slightly expired numbers. If a number is stolen from one of these forms, and used to process a fraudulent transaction (which more than likely will happen via a different channel) the transaction will be denied if processed via any method other than paper forms. Furthermore, the amount of paper authorization forms in existence are ever decreasing in favor of real time authentication methods. The use of verifying information such as expiration date, user name, zip code, etc., reduce the likelihood that the system will match a transactional cc number to an incorrect underlying credit card number.

### Protection Against Paper Authorization Form Vulnerabilities

Someone intercepts the form and copies down the card number

In this case, the interceptor will be using an expired number. If they try to use it via point of sale or card not present transactions, the number will be recognized as expired. If they use it via a paper form retailer, it will take an additional few days to be processed, at which point, the number will be expired, even for a paper form based authorization. Furthermore, the amount of paper authorization forms in existence are ever decreasing in favor of real time authentication methods.

Someone intercepts transmission from retailer to bank

In this case, the interceptor will be using an expired number. If they try to use it via point of sale or card not present transactions, the number will be recognized as expired. If they use it via a paper form retailer, it will take an additional few days to be processed, at which point, the number will be expired, even for a paper form based authorization. Furthermore, the amount of paper authorization forms in existence are ever decreasing in favor of real time authentication methods.

### Operation of the Invention

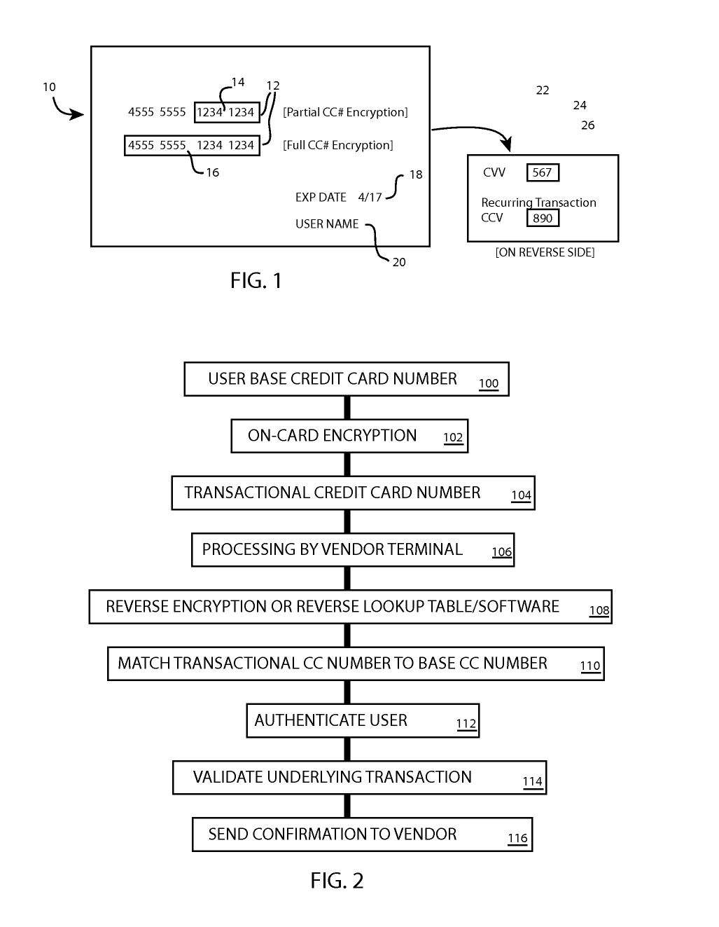

As shown in FIG. 1, a credit card 10 has preferably either a display screen 12 capable of showing either a fully generated transactional credit card number 14 or a partially generated number 16. The card preferably also includes standard information such as the expiration date 18 of the card and the user name 20.

In use, a user receives a dynamic credit card 10 associated with his underlying account credit card number (“base credit card number”) 100 (FIG. 2). To complete a secure transaction that cannot be coopted and used at a later date, the credit card does not display the base credit card number, but instead uses on-card encryption 102 to generate and/or display a transactional credit card number 104 that may be may include a portion of the base number 16 or only digits that are generated into the transactional credit card number 14.

The transactional cc number is then provided to the vendor terminal 106 via magnetic strip, RFID, manual entry or by other known methods. The transactional cc number along with other identifying/corroborating information such as expiration date, user name, CVV number, zip code, and/or street address are sent to a credit card processing backend server for verification/authorization. The server then uses reverse encryption or a generated reverse lookup table 108 of all possible transactional cc numbers in the relevant time period(s) for each account served by the credit card processor. A base/underlying credit card number is identified 110 from the look up table or reverse encryption process. Alternatively, the user is identified from the corroborating data and the transactional cc number is verified from the base cc number by parallel encryption on the server to the credit card using the same encryption process and seed.

The match between the base credit card number and the transactional cc number is then authenticated 112 by comparing the corroborating information such as the CVV, etc. to ensure that the transactional cc number can only match to one base cc number. The underlying transaction is then approved or disapproved 114 for the amount requested versus the credit available and/or for other standard credit card transaction reasons. Confirmation 116 is then sent back to the vendor to authorize the transaction.

At some near future point, the number used in the transaction, namely the transactional cc number will expire as the valid time period for the transaction will change to a new time period and the transactional cc number will no longer match the calculated (“encrypted”) transactional credit card number for the underlying base credit card number. This will prevent the transactional credit card number from being posted or sold on-line to other users for fraudulent transactions as the number will have expired prior to potential use by others. The length of the credit card number and the level of encryption will make it unlikely that a random number given to a vendor will properly match to a valid underlying cc number especially with the corroborating information matching as well (e.g., the CCV and expiration date). In this way, the amount of fraud by capturing or hacking existing credit card numbers for use in later transactions will be reduced.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims. It is therefore to be understood that the present invention is not limited to the sole embodiment described above, but encompasses any and all embodiments within the scope of the following claims.

I claim:

1. A system for generating a dynamic transactional credit card number for use in a transaction, comprising:
a card having a number generator and having a pre-stored base credit card number;
a user using the on card generator to generate a transactional credit card number from the base credit card number, where said transactional credit card number is different from the base credit card number;
providing the transactional credit card number to a vendor as part of a payment transaction for a good or service;
the vendor submitting the transactional credit card number to a computerized server of a credit card processing center;
said server identifying the base credit card number from the transaction credit card number;
said server authorizing the payment transaction as approved by the credit card processing center without submitting the base credit card number to the vendor;
said vendor providing the good or service to the user in exchange for the payment transaction.

2. A system for generating a dynamic transactional credit card number for use in a transaction during a limited time period, comprising:
a card having a number generator, a magnetic strip, a pre-stored number generator seed number, and a pre-stored base credit card number;
a user using the on card generator to generate a transactional credit card wherein said generation includes initiating generation of the transactional credit card number by determining a transaction time period from the current time of day at the time of the number generation and entering the transaction time period, the base credit card number, and the seed number in the number generator to generate the transactional credit card number, where said transactional credit card number is different from the base credit card number and where the transactional credit card number has the same number of digits as the base credit card number;
providing the transactional credit card number to a vendor in place of the base credit card number as part of a payment transaction for a good or service;
the vendor submitting the transactional credit card number to a computerized server of a credit card processing center for processing of the payment transaction;
said server identifying the base credit card number of the user by decrypting the transaction credit card number.

3. The system for generating a dynamic transactional credit card number of claim 2, further comprising:
said server authorizing the payment transaction for an account associated with the user as approved by the credit card processing center without submitting the base credit card number to the vendor; and
said vendor providing the good or service to the user in exchange for the payment transaction.

4. The system for generating a dynamic transactional credit card number of claim 2, wherein said transactional credit card number is transmitted to the vendor by a vendor terminal reading the generated transactional credit card number from a magnetic strip on said credit card.

5. The system for generating a dynamic transactional credit card number of claim 4, wherein said transactional credit card number expires within one day after generation and while expired is no longer capable of being used to authorize a payment transaction from the user.

6. The system for generating a dynamic transactional credit card number of claim 3, wherein said transactional credit card number expires within five minutes after generation and while expired is no longer capable of being used to authorize a payment transaction from the user.

7. The system for generating a dynamic transactional credit card number of claim 4, wherein said number generator generates a new transactional credit card number for each new transaction time period wherein said new transactional credit card number is distinct from the previous transaction time period.

8. The system for generating a dynamic transactional credit card number of claim 4, wherein said card and said computerized server each include the same number generator routine and include a seed number associated with the user associated with the card.

9. A system for generating a dynamic transactional credit card number for use in a transaction during a limited time period, comprising:
a card having a number generator, a magnetic strip simulator, a pre-stored number generator seed number, and a pre-stored base credit card number;
a user using the on card generator to generate a transactional credit card wherein said generation includes initiating generation of the transactional credit card number by determining a transaction time period from the current time of day at the time of the number generation and computing from the transaction time period, the base credit card number, and the seed number in the number generator a transactional credit card number, where said transactional credit card number is different from the base credit card number and where the transactional credit card number has the same number of digits as the base credit card number;
writing said transactional credit card number to the card magnetic strip simulator for use in transferring the transactional credit card number from the magnetic strip simulator to a credit card swiping terminal.
